(19) United States
(12) Patent Application Publication
(10) Pub. No.: US 2021/0230344 A1
(43) Pub. Date: Jul. 29, 2021

(54) THERMOPLASTIC POLYURETHANE COMPOSITION AND USE THEREOF

(71) Applicants: Covestro Intellectual Property GmbH & Co. KG, Leverkusen (DE); Haining Xin Gao Fibres Ltd., Yuanhua Town, Haining, Zhejiang (CN)

(72) Inventors: Wing Cheung Chan, Tai Po (HK); Yuk Ki Lee, Tuen Mun, NT (HK); Yao-chia Yang, Changhua County (TW); Gendi Gan, Haining City, Zhejiang Province (CN); Lizhong Zhu, Haining City, Zhejiang Province (CN); Tongjian Zhang, Yuanhua Town, Haining Zhejiang Province (CN); Shengjie Zou, Dingqiao Town, Haining Zhejiang Province (CN)

(21) Appl. No.: 17/050,004

(22) PCT Filed: May 6, 2019
(86) PCT No.: PCT/EP2019/061593

§ 371 Date: Oct. 23, 2020

(30) Foreign Application Priority Data
May 11, 2018 (CN) PCT/CN2018/086467

(51) Int. Cl. C08G 18/42; C08G 18/76; D01F 8/16; C08K 5/00; C08K 5/5393; C08K 5/12; C08K 5/5419

(52) U.S. Cl. CPC C08G 18/4277; C08G 18/4238; C08G 18/7671; C08K 5/5419; C08K 5/005; C08K 5/5393; C08K 5/12; D01F 8/16

(57) ABSTRACT

The present invention relates to a thermoplastic polyurethane composition and use thereof. The thermoplastic polyurethane composition comprises a polyurethane prepared from a polyester polyol and a polyisocyanate as well as an antioxidant. The thermoplastic polyurethane composition of the present invention can be used with other thermoplastic polymers in melt spinning process to prepare bicomponent fibers.

### FIELD OF THE INVENTION

The present invention relates to the field of polyurethanes. In particular, the present invention relates to a thermoplastic polyurethane composition, a bicomponent fiber comprising the same and a method for preparing the bicomponent fiber. The present invention also relates to use of the bicomponent fiber.

### BACKGROUND OF THE INVENTION

Nylon fabrics with excellent durability, strength, softness and gloss have long been used as basic materials for clothing and textiles. Spandex fibers are often added to nylon-based fabrics to further provide elasticity and comfort, thus making the fabrics very popular in next-to-skin applications (such as underclothes, shapewear, swimwear and sportswear).

Manufacturers in the textile industry have always been devoted to the development of polyurethane-containing bicomponent or multicomponent fibers. For example, some manufacturers prepare bicomponent fibers by a solution spinning process. However, this method results in the inclusion of impurities (such as solvents, monomers and oligomers) in the final fibers, and these impurities have a negative impact on the mechanical properties or durability of the fibers or human health.

Some manufacturers obtain polyurethane-coated nylon or PET fibers by extrusion coating of polyurethanes onto nylon or PET fibers. However, the fibers obtained in this way have a minimum diameter of 0.1 mm. In addition, for polyurethane-coated PET fibers, polyurethane coatings and PET fibers are easily separated due to poor compatibility between polyurethanes coating and PET fibers.

Some manufacturers are also trying to prepare polyurethane-containing bicomponent fibers by melt composite spinning. For example, EP 1,944,396A1 discloses an elastomeric core-sheath conjugate fiber useful for stretchable clothing prepared by a melt composite spinning process, wherein both of the core and the sheath are made of TPU. However, for the preparation of bicomponent fibers comprising polyurethanes and other thermoplastic polymers other than polyurethanes, the spinning temperature of polyurethanes is generally about 195-205° C., while the spinning temperature of polyamides, polyethylene terephthalate and the like is over 230° C. If spinning is performed at this temperature, polyurethanes will be greatly degraded, with the result that the strength of the resulting bicomponent fibers is decreased, the fibers are easily broken, spinning is thus interrupted and spinnerets must be cleaned, thereby increasing the production cost and reducing the production efficiency.

It is therefore desirable in the art to develop a new polyurethane component for preparing a bicomponent fiber, which can be subjected to melt spinning with other thermoplastic polymers to obtain bicomponent fibers.

### SUMMARY OF THE INVENTION

An object of the present invention is to provide a new polyurethane component for preparing a bicomponent fiber, which can be subjected to melt spinning with other thermoplastic polymers to obtain bicomponent fibers.

According to a first aspect, the present invention provides a thermoplastic polyurethane composition, which comprises a polyurethane prepared from a polyester polyol and a polyisocyanate as well as an antioxidant.

According to a second aspect, the present invention provides a bicomponent fiber comprising:

i) the thermoplastic polyurethane composition of the present invention as a first component; and

ii) a thermoplastic polymer other than the first component as a second component.

According to a third aspect, the present invention provides a method for preparing the bicomponent fiber of the present invention, which comprises the following steps:

a) the first component and the second component are melted in separate extruders;

b) the first component and the second component are extruded together by a spinning pack with one or more nozzles to obtain the bicomponent fiber; and

c) the bicomponent fiber is wound into a filament coil by a winding roller.

According to a fourth aspect, the present invention provides a woven or knitted fabric, which comprises the bicomponent fiber of the present invention as a warp yarn or a weft yarn or both.

The thermoplastic polyurethane composition of the present invention can withstand a processing temperature of 220-280° C., and therefore can be subjected to melt composite spinning with many thermoplastic polymers to prepare bicomponent fibers. The properties of bicomponent fiber of the present invention are wear resistant, being formed into 3D embossing effect, having good hepatic feeling, recyclable, dye-able with disperse and acid dyes, and used to prepare various types of woven or knitted fabrics for various applications, e.g. shoe uppers, outer layers of gloves, outer layers of bags, clothing and the like.

### BRIEF DESCRIPTION OF THE DRAWINGS

The present invention will be described below in conjunction with the following drawings, in which:

FIG. 1 is a schematic flow chart of a method for preparing a bicomponent fiber according to one embodiment of the present invention;

FIG. 2 is a schematic sectional view of a sheath-core (concentric) bicomponent fiber according to one embodiment of the present invention;

FIG. 3 is a schematic sectional view of a sheath-core (eccentric) bicomponent fiber according to one embodiment of the present invention;

FIG. 4 is a schematic sectional view of a side-by-side bicomponent fiber according to one embodiment of the present invention;

FIG. 5 is a schematic sectional view of a sea-island bicomponent fiber according to one embodiment of the present invention;

FIG. 6 is a photograph of a bicomponent fiber/PET fiber blended fabric dyed with a disperse dye in Example 9, wherein the dark color denotes the bicomponent fiber and the light color denotes PET fibers; and

FIG. 7 is a photograph of a bicomponent fiber fabric dyed with an acid dye in Example 10.

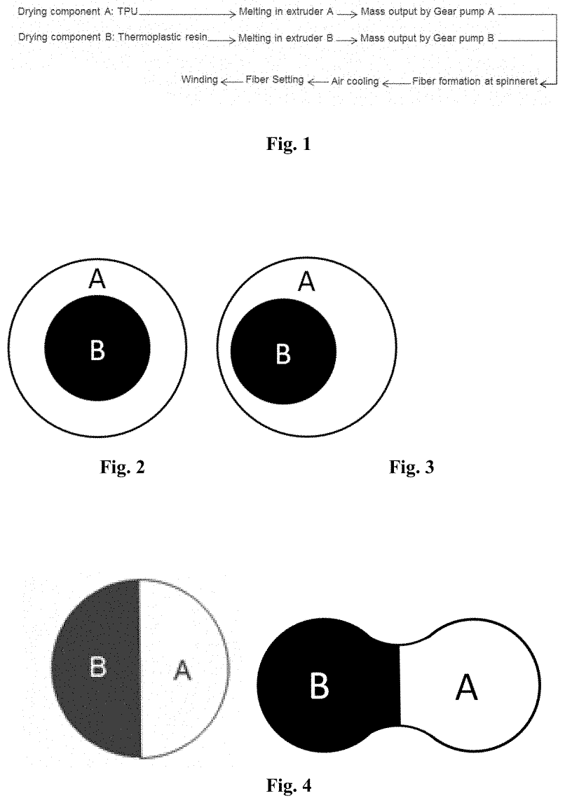

### DETAILED DESCRIPTION OF THE INVENTION

Some specific embodiments of the present invention will be described below.

According to a first aspect, the present invention provides a thermoplastic polyurethane composition, which comprises a polyurethane prepared from a polyester polyol and a poly-isocyanate as well as an antioxidant.

In some embodiments, the thermoplastic polyurethane composition further comprises a silicone-based lubricant agent.

The polyester polyol is preferably selected from a polycyclolactone diol and a polyester diol.

Examples of polycyclolactone diols may include polycycloheptanolactone diols, polycyclocaprolactone diols, polycyclovalerolactone diols, polycyclobutyrolactone diols and polycyclopropiolactone diols.

The polycyclolactone diol has a weight-average molecular weight of preferably 2500-4000 g/mol, more preferably 2800-3500 g/mol.

The polyester diol is preferably a linear polyester diol. The polyester diol can be prepared by polycondensation of a dicarboxylic acid and a diol. Examples of dicarboxylic acids for preparing polyester diols may include adipic acid, glutaric acid, succinic acid, malonic acid and possible structural isomers thereof. Examples of diols for preparing polyester diols may include hexanediol, pentanediol, butanediol, propylene glycol, ethylene glycol and possible structural isomers thereof.

The polyester diol has a weight average molecular weight of preferably 1000-4000 g/mol, more preferably 1500-3500 g/mol.

The poly-isocyanate is preferably selected from diisocyanates commonly used in the field of thermoplastic polyurethanes, for example, vinyl diisocyanate, 1,4-tetramethylene diisocyanate, hexamethylene diisocyanate (HDI), 1,2-dodecane diisocyanate, cyclobutane-1,3-diisocyanate, cyclohexane-1,3-diisocyanate, cyclohexane-1,4-diisocyanate, 1-isocyanate-3,3,5-trimethyl-5-isocyanate methylcyclohexane, hexahydrotoluene-2,4-diisocyanate, hexahydrophenyl-1,3-diisocyanate, hexahydrophenyl-1,4-diisocyanate, perhydrogenated diphenylmethane-2,4-diisocyanate, perhydrogenated diphenylmethane-4,4-diisocyanate, phenylene-1,3-diisocyanate, phenylene-1,4-diisocyanate, toluylene-1,4-diisocyanate, 3,3-dimethyl-4,4-diphenyl diisocyanate, tolylene-2,4-diisocyanate (TDI), tolylene-2,6-diisocyanate (TDI), diphenylmethane-2,4′-diisocyanate (MDI), diphenylmethane-2,2′-diisocyanate (MDI), diphenylmethane-4,4′-diisocyanate (MDI), diphenylmethane diisocyanate and/or mixtures of diphenylmethane diisocyanate homologues with more rings, polyphenylmethane polyisocyanate (polymerized MDI), naphthylene-1,5-diisocyanate (NDI) and mixtures thereof.

Those skilled in the art can readily determine the amount of the di-isocyanate required based on the amount of the polyester polyol used.

The oxidant may be an antioxidant commonly used in the field of fiber preparation.

The antioxidant is preferably selected from one or more of phosphorus-based antioxidants and phenol-containing antioxidants that are well known in the art.

Commercial examples of antioxidants may include Irgafos 126, Irganox 1010 and the like provided by BASF Corporation.

According to one embodiment, the antioxidant comprises Irgafos 126 and Irganox 1010.

The content of the antioxidant in the thermoplastic polyurethane composition is preferably 0.5-1.5 wt. %, more preferably 0.7-1.2 wt. %, based on the total weight of the thermoplastic polyurethane composition.

According to one embodiment, the antioxidant comprises 0.15-0.30 wt. % of Irgafos 126 and 0.25-0.40 wt. % of Irganox 1010 based on the total weight of the thermoplastic polyurethane composition.

The silicone-based lubricant agent is a silicone-based lubricant commonly used in the art, preferably a copolymer of polydimethylsiloxane and polyethylene glycol having a weight-average molecular weight of 1500-3000 (e.g. a weight-average molecular weight of 2000), for example, DOW CORNING SF8427.

The content of the silicone-based lubricant in the thermoplastic polyurethane composition is preferably 0.2-1.0 wt. %, more preferably 0.4-0.7 wt. %, based on the total weight of the thermoplastic polyurethane composition.

The thermoplastic polyurethane composition of the present invention is resistant to high temperatures and can withstand a high temperature of 260° C., even 285° C.

The thermoplastic polyurethane composition of the present invention can have a Shore hardness of 88-92A.

The thermoplastic polyurethane composition of the present invention has a shear viscosity of 60-200 Pa-s as measured at 230° C. and 100 s⁻¹.

The thermoplastic polyurethane composition of the present invention can be prepared according to a process for preparing polyurethane resin in the art, wherein an antioxidant and an optional silicone-based lubricant are added.

For example, the thermoplastic polyurethane composition of the present invention can be prepared by reacting a polyester polyol with a polyisocyanate using a prepolymerization method to form a prepolymer, and then adding a chain extender, an antioxidant and an optional silicone-based lubricant to continue the reaction, wherein the chain extender used is a chain extender commonly used in the preparation of thermoplastic polyurethanes.

According to a second aspect, the present invention provides a bicomponent fiber comprising:

i) the thermoplastic polyurethane composition of the present invention as a first component; and

ii) a thermoplastic polymer other than the first component as a second component.

The fiber fineness of individual bicomponent fiber is 2-30 denier, preferably 2-10 denier. The second component is selected from polyamides (PA), polymethyl methacrylate (PMMA), polyoxymethylene (POM), polylactic acid (PLA), polytrimethylene terephthalate (PTT), polybutylene terephthalate (PBT), polyethylene terephthalate (PET), polypropylene (PP), and thermoplastic polyurethanes having a Shore hardness of greater than 95.

In the bicomponent fiber, the first component is present in the bicomponent fiber in an amount of preferably 30-70 wt. %, more preferably 40-60 wt. %, based on the total weight of the bicomponent fiber.

In the bicomponent fiber, the second component is present in the bicomponent fiber in an amount of preferably 70-30 wt. %, more preferably 60-40 wt. %, based on the total weight of the bicomponent fiber.

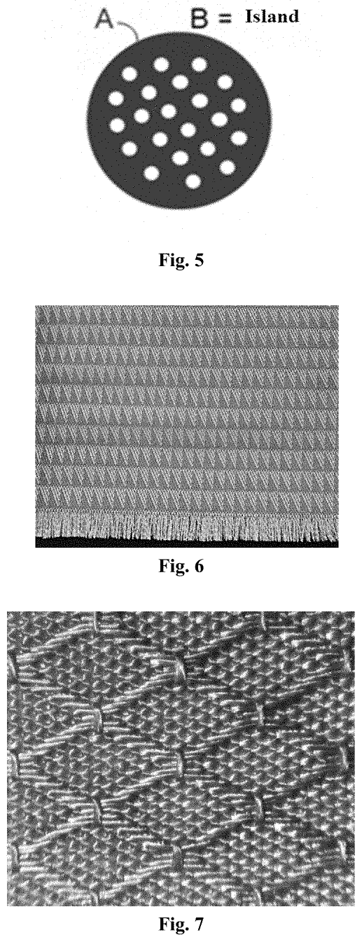

The bicomponent fiber may be selected from sheath-core (see FIGS. 2 and 3), side-by-side (see FIG. 4) and sea-island (see FIG. 5) bicomponent fibers.

The sheath-core bicomponent fiber may be concentric (see FIG. 2) or eccentric (see FIG. 3), preferably be concentric.

The first component serves as a sheath or core, preferably as a sheath in the sheath-core bicomponent fiber.

The second component serves as an island or sea in the sea-island bicomponent fiber.

Neither of the first component and the second component for preparing the bicomponent fiber of the present invention comprises a crosslinking agent, especially a non-polyether crosslinking agent.

The bicomponent fiber of the present invention can be dyed with a disperse dye (e.g. DyStar Diamix® Blue and Yellow series) and an acid dye (e.g. Acid Yellow 199 and Acid Blue 62) or the like.

In the case of dyeing with a disperse dye, the dyeing temperature is 100-150° C., preferably 130° C., and the dyeing time is over 60 min, e.g. 60-70 min.

In the case of dyeing with an acid dye, the dyeing temperature is 80-120° C., preferably 100° C., and the dyeing time is over 45 min, e.g. 45-60 min.

The bicomponent fiber of the present invention can be prepared into a fabric by a weaving or knitting process.

The bicomponent fiber of the present invention can serve as a warp yarn, a weft yarn or both.

Suitable weaving apparatuses may be, for example, air-jet looms, water-jet looms, rapier looms and the like.

Suitable knitting apparatuses may be, for example, flat knitting machines, circular knitting machines and the like. When a flat knitting machine is used for processing, a ceramic guide nozzle is preferably used.

The fabric may be, for example, a web or the like.

According to a third aspect, the present invention provides a method for preparing the bicomponent fiber of the present invention, which comprises the following steps:

a) the first component and the second component are melted in separate extruders;

b) the first component and the second component are extruded together by a spinning pack with one or more nozzles to obtain the bicomponent fiber; and

c) the bicomponent fiber is wound into a filament coil by a winding roller.

Preferably, in the step a), the first component and the second component are melted at a temperature in the range of 200-285° C., preferably 205-270° C.

The first component and the second component can be melted at different temperatures. For example, the first component can be melted at a temperature in the range of 200-240° C., preferably 205-230° C.

Those skilled in the art can readily determine the temperature at which the second component is melted according to the second component used. For example, when the second resin is a polyamide, the second resin can be melted at a temperature in the range of 230-280° C., preferably 240-270° C.

Preferably, in the step b), the spinning pack has a temperature in the range of 220-285° C., preferably 230-260° C. and more preferably 230-240° C.

Optionally, after the first component and the second component are extruded to obtain the bicomponent fiber, a lubricating oil is added to the bicomponent fiber. For example, a lubricating oil can be added to the bicomponent fiber by spraying or a roller.

Optionally, prior to winding, the bicomponent fiber is drawn, preferably thermally-drawn. For example, the bicomponent fiber can be thermally-drawn using a heated roller.

Preferably, in the step c), the winding speed of the winding roller is 600-4000 m/min, preferably 1000-3500 m/min.

Optionally, the bicomponent fiber is cooled to room temperature by cold air prior to the step c).

Optionally, the bicomponent fiber is twisted by a twisting machine to obtain a twisted fiber.

In the preparation of the bicomponent fiber of the present invention, a crosslinking agent, especially a non-polyether crosslinking agent is not used.

According to a fourth aspect, the present invention provides a woven or knitted fabric, which comprises the bicomponent fiber of the present invention as a warp yarn or a weft yarn or both.

The bicomponent fiber can present 10-100 wt. % of the woven or knitted fabric.

By incorporating the bicomponent fiber of the present invention into the fabric (e.g. a web), the performance of the fabric (e.g. a web) may have the following changes:
the surface friction is increased;
the wear resistance is improved;
the tear strength is improved after heat treatment;
the hot pressing process at a low temperature such as 110-130° C. is improved to obtain a three-dimensional embossed pattern;
in the secondary molding by an insert injection molding method, the adhesion between the fabric and other polymers such as TPU, TPE (thermoplastic elastomers) and TPEE (thermoplastic polyester elastomers) available on the market is improved, for example, the adhesion is improved when other polymers are directly injection-molded onto the fabric (e.g. a web) by means of insert injection molding;
a solid hand feeling is provided; and
when the bicomponent fiber is blended with a polyester fiber and a nylon fiber, the fibers can be dyed at the same time without respective color matching.

Fibers that can be woven or knitted together with the bicomponent fiber of the present invention are, for example, polyester fibers (e.g. PET fiber), polyamide fibers, viscose fibers, cotton fibers, spandex fibers, Dyneema® (DSM), Kevlar® (Dupont), Cordura® (Dupont), etc.

The woven or knitted fabric can be used for shoe uppers, shoelaces, outer layers of gloves, outer layers of bags, sandwich mesh fabrics, furniture fabrics, clothing and the like.

In the description and claims of the present application, all numbers expressing quantities, percentages, parts by weight and the like should be understood in all instances to be modified by the term “about”.

The present invention will be described in detail with reference to the following specific examples. However, it will be readily understood by those skilled in the art that the examples herein are for illustrative purposes only and the scope of the present invention is not limited thereto.

### EXAMPLES

Raw Materials Used:

PLA:

| Index | Unit | Values | Test methods |
|---|---|---|---|
| Specific weight | g/cm³ | 1.24 | D792 |
| Relative viscosity | | 3.1 ± 0.1 | CD Internal Viscotek method |
| Melt index | g/10 min | 15-30 | D1238 |
| | (210° C.) | | |
| Melting point | ° C. | 155-170 | D3417 |
| Glass temperature | ° C. | 55-60 | D3418 |
| Water content | % | ≤0.04 | Karl Fischer |

PA1 and PA2:

| | | PA1 | PA2 | |
|---|---|---|---|---|
| Index | Unit | values | values | Test methods |
| Specific weight | g/cm³ | 1.14 | 1.13 | ISO 1183 |
| Viscosity | cm³/g | 153 | | ISO 1628-1 |
| Bulk density | Kg/m³ | ~700 | ~670 | ISO 60 |
| Melting point | ° C. | ~210 | ~220 | ISO 1346 C, |
| | | | | 10K/min |
| Water content | % | ≤0.02 | ≤0.06 | Karl Fischer |
| Terminal amino group | % | | 43 ± 2 | |
| Extract | % | | ≤0.6 | |

Test Methods:

The Shore hardness is determined by a hardometer according to ISO 868:2003.

The viscosity is determined using a capillary tube and a slit-die rheometer according to ISO 11443:2005.

The melting point is determined by DSC according to ASTM D3418/E1356.

The fineness, tensile strength and elongation at break are determined according to GB/T 14343-2008.

The shrinkage ratio is determined according to GB/T 6505-2008.

The oil content is determined according to GB/T 6504-2008.

The color fastness to sunlight is tested under the test conditions of 550 W and a black body temperature of 70° C. for 2 h according to Adidas FT-11.

The color fastness to migration is tested under the test conditions of 45 N and 50° C. for 16 h according to Adidas FT-02.

The Courtauld test is carried out under the test conditions of 45 N and 50° C. for 16 h according to Adidas FT-08.

In the following examples, the content of components are all based on their weight.

### Example 1

59.8 g of polybutylene glycol adipate (having a weight average molecular weight of 1500) and 30.9 g of diphenylmethane-4,4-diisocyanate were reacted at 210-230° C. for about 1 min using a prepolymerization method to form a polymer, and then 7.8 g of 1,4-butanediol, 0.125 g of Irganox 1010 and 0.125 g of Irgafos 126 were added. The temperature was controlled at 230° C. and the reaction was continued for 30 s to obtain the thermoplastic polyurethane composition TPU1.

### Example 2

59.3 g of polybutylene glycol adipate (having a weight average molecular weight of 2000) and 30.4 g of diphenylmethane-4,4-diisocyanate were reacted at 210-230° C. for about 1 min using a prepolymerization method to form a polymer, and then 8.3 g of 1,4-butanediol, 0.31 g of Irganox 1010, 0.31 g of Irgafos 126 and 0.5 g of a silicone-based lubricant (DOW CORNING SF8427) were added. The temperature was controlled at 230° C. and the reaction was continued for 30 s to obtain the thermoplastic polyurethane composition TPU2.

### Example 3

58.8 g of a cyclocaprolactone diol (having a weight average molecular weight of 3000) and 30.1 g of diphenylmethane-4,4-diisocyanate were reacted at 210-230° C. to form a polymer until the temperature reached 225° C. for about 1 min, and then 9.1 g of 1,4-butanediol, 0.31 g of Irganox 1010, 0.31 g of Irgafos 126 and 0.5 g of a silicone-based lubricant (DOW CORNING SF8427) were added. The temperature was controlled at 230° C. and the reaction was continued for 30 s to obtain the thermoplastic polyurethane composition TPU3.

TABLE 1
the performance of the thermoplastic polyurethane
compositions prepared in Examples 1-3

| | Unit | TPU1 | TPU2 | TPU3 |
|---|---|---|---|---|
| Shore hardness | Shore A | 88-91 | 88-91 | 88-91 |
| Viscosity (230° C./100⁻¹) | Pa · s | 115-120 | 115-120 | 125-130 |
| Melting point (Tₘ) | ° C. | 170 | 170 | 210 |

### Example 4

The TPU1 obtained in Example 1 and PLA were respectively dried in a dehumidifier until the water content therein was lower than 100 ppm. The dried TPU1 and PLA were respectively fed into two separate single-screw extruders A and B, wherein the temperature of the screw extruder A was 205° C. and the temperature of the screw extruder B was 230° C. The TPU1 and the PLA were fed in a weight ratio of 50:50 into a spinning pack maintained at 230° C. via a gear pump, a melt was extruded into bicomponent fibers through spinneret orifices (6 orifices) on a spinneret, and the bicomponent fibers were air-cooled (at 23° C. and 0.4 m/s), oiled, set and wound (at a winding speed of 2800 m/min) into a filament coil. Spinning was stably performed for more than 72 h, the pressure rise of the pack was less than 10 MPa within 72 h, and the times of interruption during spinning was less than 10 times within 72 h.

The structural and performance parameters of the fibers are summarized in Table 2.

### Example 5

The TPU2 obtained in Example 2 and PA1 were respectively dried in a dehumidifier until the water content therein was lower than 100 ppm. The dried TPU2 and PA1 were respectively fed into two separate single-screw extruders A and B, wherein the temperature of the screw extruder A was 205° C. and the temperature of the screw extruder B was 260° C. The TPU2 and the PA1 were fed in a weight ratio of 50:50 into a spinning pack maintained at 232° C. via a gear pump, a melt was extruded into bicomponent fibers through spinneret orifices (72 orifices) on a spinneret, and the bicomponent fibers were air-cooled (at 23° C. and 0.4 m/s), oiled, set and wound (at a winding speed of 2800 m/min) into a filament coil. Spinning was stably performed for more than 72 h, the pressure rise of the pack was less than 10 MPa within 72 h, and the times of interruption during spinning was less than 10 times within 72 h.

The structural and performance parameters of the fiber are summarized in Table 2.

### Example 6

The TPU2 obtained in Example 2 and PA1 were respectively dried in a dehumidifier until the water content therein was lower than 100 ppm. The dried TPU2 and PA were respectively fed into two separate single-screw extruders A and B, wherein the temperature of the screw extruder A was 205° C. and the temperature of the screw extruder B was 260° C. The TPU2 and the PA1 were fed in a weight ratio of 65:35 into a spinning pack maintained at 232° C. via a gear pump, a melt was extruded into bicomponent fibers through spinneret orifices (72 orifices) on a spinneret, and the bicomponent fibers were air-cooled (at 23° C. and 0.4 m/s), oiled, set and wound (at a winding speed of 2800 m/min) into a filament coil. Spinning was stably performed for more than 72 h, the pressure rise of the pack was less than 10 MPa within 72 h, and the times of interruption during spinning was less than 10 times within 72 h.

The structural and performance parameters of the fiber are summarized in Table 2.

### Example 7

The TPU3 obtained in Example 3 and PA2 were respectively dried in a dehumidifier until the water content therein was lower than 100 ppm. The dried TPU3 and PA2 were respectively fed into two separate single-screw extruders A and B, wherein the temperature of the screw extruder A was 205° C. and the temperature of the screw extruder B was 265° C. The TPU3 and the PA2 were fed in a weight ratio of 50:50 into a spinning pack maintained at 240° C. via a gear pump, a melt was extruded into bicomponent fibers through spinneret orifices (216 orifices) on a spinneret, and the bicomponent fibers were air-cooled (at 23° C. and 0.4 m/s), oiled, set and wound (at a winding speed of 2800 m/min) into a filament coil. Spinning was stably performed for more than 72 h, the pressure rise of the pack was less than 10 MPa within 72 h, and the times of interruption during spinning was less than 10 times within 72 h.

The structural and performance parameters of the fiber are summarized in Table 2.

### Example 8

The TPU3 obtained in Example 3 and PA2 were respectively dried in a dehumidifier until the water content therein was lower than 100 ppm. The dried TPU3 and PA2 were respectively fed into two separate single-screw extruders A and B, wherein the temperature of the screw extruder A was 205° C. and the temperature of the screw extruder B was 265° C. The TPU3 and the PA2 were fed in a weight ratio of 50:50 into a spinning pack maintained at 240° C. via a gear pump, a melt was extruded into bicomponent fibers through spinneret orifices (106 orifices) on a spinneret, and the bicomponent fibers ware air-cooled (at 23° C. and 0.4 m/s), oiled, set and wound (at a winding speed of 2800 m/min) into a filament coil. Spinning was stably performed for more than 72 h, the pressure rise of the pack was less than 10 MPa within 72 h, and the times of interruption during spinning was less than 10 times within 72 h.

The structural and performance parameters of the fiber are summarized in Table 2.

TABLE 2
the structural and performance parameters of the bicomponent fibers prepared in Examples 4-8

| | Structures | | | | Performance | | | | |
|---|---|---|---|---|---|---|---|---|---|
| | | | | Sheath/core | | Tensile | Elongation | Shrinkage | Oil |
| | Types of | | | ratio | Fineness | strength | at break | ratio | content |
| Ex. | fibers | Sheath | Core | (%) | (D/F) | (cN/dtex) | (%) | (%) | (%) |
| Ex. 4 | Concentric | TPU1 | PLA | 50:50 | 182.9/6 | 1.34 | 61.3 | 1.6 | 0.95 |
| Ex. 5 | Concentric | TPU2 | PA1 | 50/50 | 155.0/72 | 3.23 | 59.3 | 3.5 | 0.91 |
| Ex. 6 | Concentric | TPU2 | PA1 | 65/35 | 156.5/72 | 2.79 | 56.5 | 7.5 | 0.92 |
| Ex. 7 | Concentric | TPU3 | PA2 | 50/50 | 452/216 | 2.51 | 69.1 | 14.3 | 0.87 |
| Ex. 8 | Concentric | TPU3 | PA2 | 50/50 | 302/106 | 2.59 | 71.0 | 4.5 | 0.60 |

### Example 9

A fabric comprising the bicomponent fiber of the present invention (a fabric prepared by blending 60% of the bicomponent fiber and 40% of PET fiber) was dyed with a disperse dye by the following process.

100 g of the fabric was placed in a dyeing vessel for a general cleaning procedure, then 4 g of a disperse dye (DyStar Diamix® Blue series) was dissolved in 400 ml of water at 50-60° C., and the pH was adjusted to 4-5 with acetic acid. After the temperature remained stable for 10 min, the temperature of the dyeing vessel was increased to 130° C. and maintained for 60-70 min. The temperature of the dyeing vessel was lowered to 70-80° C. and the fabric was flushed with hot water for 10-15 min. The fabric was taken out from the dyeing vessel and placed in a cleaning cylinder containing sodium hydrosulfite and sodium hydroxide for 10-15 min cleaning. Finally, the fabric was flushed with clean water and oven-dried.

A photograph of the dyed fabric is shown in FIG. 6. The color fastness of the dyed fabric was tested. The results are shown in Table 3. The photograph and test results show that the bicomponent fiber of the present invention can be dyed with a disperse dye.

### Example 10

A fabric comprising the bicomponent fiber of the present invention (a fabric comprising 100% of the bicomponent fiber) was dyed with an acid dye by the following process.

100 g of the fabric was placed in a dyeing vessel for a general cleaning procedure. The pH was adjusted to 4-5.5 with acetic acid and the temperature was maintained at 40-50° C. for 10-15 min. An acid dye (Acid Yellow 199) was added, and the temperature was increased to 70-75° C. and maintained for 10-15 min, and then increased to 90-100° C. and maintained for 45-60 min. Finally, the fabric was respectively flushed with hot water at 70° C. and cold water for 10 min and oven-dried.

A photograph of the dyed fabric is shown in FIG. 7. The color fastness of the dyed fabric was tested. The results are shown in Table 3. The photograph and test results show that the bicomponent fiber of the present invention can be dyed with an acid dye.

TABLE 3
test results of color fastness

| | Color fastness | Color fastness to | |
|---|---|---|---|
| Ex. | to sunlight | migration | Courtauld test |
| Ex. 9 | 4-5 | 4-5 | 4-5 |
| Ex. 10 | 4-5 | 4-5 | 3-4 |

Although some aspects of the present invention have been shown and discussed, those skilled in the art should recognize that changes can be made to the above aspects without departing from the principles and spirit of the present invention, and therefore the scope of the present invention will be defined by claims and their equivalents.

1. A thermoplastic polyurethane composition comprising a polyurethane prepared from a polyester polyol and a polyisocyanate as well as an antioxidant.

2. The thermoplastic polyurethane composition according to claim 1, further comprising a silicone-based lubricant.

3. The thermoplastic polyurethane composition according to claim 1, wherein the polyester polyol comprises a polycyclolactone diol and/or a polyester diol.

4. The thermoplastic polyurethane composition according to claim 1, wherein the polyisocyanate comprises -vinyl diisocyanate, 1,4-tetramethylene diisocyanate, hexamethylene diisocyanate, 1,2-dodecane diisocyanate, cyclobutane-1,3-diisocyanate, cyclohexane-1,3-diisocyanate, cyclohexane-1,4-diisocyanate, 1-isocyanate-3,3,5-trimethyl-5-isocyanate methylcyclohexane, hexahydrotoluene-2,4-diisocyanate, hexahydrophenyl-1,3-diisocyanate, hexahydrophenyl-1,4-diisocyanate, perhydrogenated diphenylmethane-2,4-diisocyanate, perhydrogenated diphenylmethane-4,4-diisocyanate, phenylene-1,3-diisocyanate, phenylene-1,4-diisocyanate, toluylene-1,4-diisocyanate, 3,3-dimethyl-4,4-diphenyl diisocyanate, tolylene-2,4-diisocyanate, tolylene-2,6-diisocyanate, diphenylmethane-2,4′-diisocyanate, diphenylmethane-2,2′-diisocyanate, diphenylmethane-4,4′-diisocyanate, diphenylmethane diisocyanate, mixtures of diphenylmethane diisocyanate homologues with more rings, polyphenylmethane polyisocyanate, naphthylene-1,5-diisocyanate, or a mixture thereof.

5. The thermoplastic polyurethane composition according to claim 1, wherein the content of the antioxidant is 0.5-1.5 wt. % based on the total weight of the thermoplastic polyurethane composition.

6. The thermoplastic polyurethane composition according to claim 2, wherein the content of the silicone-based lubricant is 0.2-1.0 wt. % based on the total weight of the thermoplastic polyurethane composition.

7. A bicomponent fiber comprising:
i) the thermoplastic polyurethane composition according to claim 1 as a first component; and
ii) a thermoplastic polymer other than the first component as a second component.

8. The bicomponent fiber according to claim 7, wherein the fiber fineness of individual bicomponent fiber is 2-30 denier.

9. The bicomponent fiber according to claim 7, wherein the second component comprises at least one of polyamides, polymethyl methacrylate, polyoxymethylene, polylactic acid, polytrimethylene terephthalate, polybutylene terephthalate, polyethylene terephthalate, polypropylene, or thermoplastic polyurethanes having a Shore hardness of greater than 95A.

10. The bicomponent fiber according to claim 7, wherein the first component is present in the bicomponent fiber in an amount of 30-70 wt. % based on a total weight of the bicomponent fiber.

11. The bicomponent fiber according to claim 7, wherein the second component is present in the bicomponent fiber in an amount of 70-30 wt. % based on a total weight of the bicomponent fiber.

12. The bicomponent fiber according to claim 7, wherein the bicomponent fiber comprises at least one of sheath-core, side-by-side, or sea-island bicomponent fibers.

13. The bicomponent fiber according to claim 12, wherein the first component serves as a sheath or core.

14. The bicomponent fiber according to claim 12, wherein the first component serves as an island or sea in the sea-island bicomponent fiber.

15. A method for preparing the bicomponent fiber claim 7, comprising:
a) melting the first component and the second component in separate extruders;
b) extruding the first component and the second component together by a spinning pack with one or more nozzles to obtain the bicomponent fiber; and
c) winding the bicomponent fiber into a filament coil by a winding roller.

16. The method according to claim 15, wherein the first component and the second component are melted at a temperature in the range of 200-285° C.

17. The method according to claim 15, wherein the spinning pack has a temperature in the range of 220-285° C.

18. The method according to claim 15, wherein the winding speed of the winding roller is 600-4000 m/min.

19. The method according to claim 15, wherein the bicomponent fiber is cooled to room temperature by cold air prior to winding.

20. A woven or knitted fabric, comprising the bicomponent fiber of claim 7 as a warp yarn or a weft yarn or both.
